(19) United States
(12) Patent Application Publication
(10) Pub. No.: US 2013/0033131 A1
(43) Pub. Date: Feb. 7, 2013

(54) Inductive Energy Converter

(71) Applicants: Seun K. Kahng, Poquoson, VA (US); Leopold Kahng, Vienna, VA (US); Jennifer Kahng, Centreville, VA (US)

(72) Inventors: Seun K. Kahng, Poquoson, VA (US); Leopold Kahng, Vienna, VA (US); Jennifer Kahng, Centreville, VA (US)

(73) Assignee: ATLANTIC INDUSTRIES, INC., Poquoson, VA (US)

(21) Appl. No.: 13/198,225

(22) Filed: Aug. 4, 2011

(51) Int. Cl. H02K 33/02

(52) U.S. Cl. 310/36

(57) ABSTRACT

An inductive energy converter includes a non-magnetic housing, at least one magnet and at least one induction coil disposed within the housing, and at least one spring coupled to the magnet or induction coil. Thus, the spring and the magnet or induction coil form a spring-mass system that oscillates relative to the housing when the housing is subjected to movement. The other of the magnet and induction coil does not move relative to the housing. In an alternative embodiment, human movement results in the depression of a push plate that is coupled to a wheel that causes a ring magnet to rotate relative to one or more induction coils or vice-versa. In either case, the movement of the magnet relative to the coil results in a voltage being induced on the coil according to Faraday's law.

### BACKGROUND OF THE INVENTION

a. Field of the Invention

The instant disclosure relates to energy converters. More specifically, the present disclosure relates to an electromechanical induction generator for converting mechanical energy into electrical energy.

b. Background Art

An energy converter is a device that transforms motion, such as human body movement, into electrical energy. This electrical energy can then be stored or used for other purposes. Typically, energy converters fall into one of three categories: piezoelectric, capacitive, and inductive.

Piezoelectric materials generate a voltage when they are stressed along a preferred direction. Thus, mechanical energy can be converted to electrical energy through the use of a dielectric elastomer generator. The dielectric elastomer is susceptible to various modes of failure, however, including electrical breakdown, electro-mechanical instability, loss of tension, and rupture by over-stretching. These modes of failure define a cycle of maximum energy that can be converted.

Capacitive devices are disadvantageous because they require an auxiliary electrical supply. The available electric power density to capacitive devices is also limited.

Inductive devices use Faraday's law of induction, that electrical energy is generated when a time-varying magnetic flux links to a closed loop coil. The simplified governing equation for induction voltage, which will be familiar to those of ordinary skill, is

$$V ( t ) = n \frac{\partial B}{\partial t} A .$$

Thus, the output voltage generated by the induction in the coil is proportional to the number of turns in the coil n, the rate of change in magnetic flux density that links through the coil

$$\frac{\partial B}{\partial t} ,$$

and the cross-sectional area of the coil A. Flux density B changes perpendicular to the coil's cross-sectional plane. In order to increase the output voltage, the product nA needs to be increased, which is directly related to the physical size of the induction coil's diameter. Thus, the output is related to the overall size of the induction coils and the time-varying magnetic flux that links to the coil.

Research shows that a flexible polyimide membrane of 2 mm diameter with an attached magnet produces a maximum power of 0.3 microwatts at 4.4 kHz. See C. Sherwood and R. B. Yates, “Development of an Electromagnetic Microgenerator”, Electronics Letters, v. 13, p. 1883, (1997). Amirtharajah and Chandrakasan estimate the maximum power output of small inductive harvesters at 400 microwatts at 500 kHz, and estimate that the power density that can be achieved by inductive harvesters is limited to 0.5 milliwatts/cm³. See R. Amirtharajah and A. Chandrakasan, “Self-powered Signal Processing Using Vibration-Based Power Generation”, IEEE Journal of Solid State Circuits, v. 33, n. 5, pp. 687-695 (1998).

The electromagnetic approaches are the best candidates for energy harvesting generators, producing a maximum of 2 watts for two steps per second. Electronically, the magnetic unit is far easier to work with. See P. Niu, P. Chapman, and R. Riemer, “Evaluation of Motions and Actuation Methods for Biomedical Energy Harvesting”, 2004 35^{th} Annual IEEE Power Electronics Specialist Conference, pp. 2100-2106. The theoretical maximum power density of the electromagnetic unit is rated highest (400 mW per cubic centimeter), and it does not require a high voltage circuit or smart materials like piezoelectric materials. See D. Jia and J. Liu, “Human power-based energy harvesting strategies for mobile electronic devices”, Frontier Energy Power Engineering, China 2009, 3 (1), pp. 27-46.

### BRIEF SUMMARY OF THE INVENTION

It is an object of the present invention to provide an energy converter that is capable of converting the byproduct of mechanical energy into electrical energy.

It is another object of the present invention to provide an energy converter that produces an increased power output relative to extant energy converters.

It is a further object of the present invention to provide an energy converter that exhibits an increased power density.

It is still another object of the present invention to provide an energy converter that produces an increased power output relative to extant energy converters while remaining lightweight, compact, and of sufficiently small size that it can be easily worn, carried, and/or installed within small containers, including, but not limited to, the heel of a shoe.

Disclosed herein is an inductive energy converter that includes a housing having a longitudinal axis and including an inner shell and an outer shell. The inner shell defines a travel channel substantially parallel to the longitudinal axis of the housing and the inner shell and outer shell define at least one annular chamber therebetween. At least one magnet is disposed within the travel channel, oriented such that its magnetic poles lie along an axis substantially parallel to the longitudinal axis of the housing. At least one induction coil is disposed within the at least one annular chamber, oriented with its cross-sectional area (i.e., the cross-section of the coil, not of the wire that makes up the coil) substantially perpendicular to the longitudinal axis of the housing. At least one spring is coupled to the at least one magnet and the housing such that, when the at least one magnet is set in motion via movement of the housing, the at least one magnet oscillates within the travel channel, through an interior region of the at least one induction coil, and substantially in a direction parallel to the longitudinal axis of the housing.

Preferably, the housing comprises a non-magnetic material. Thus, in some aspects of the invention, the inductive energy converter is devoid of ferromagnetic materials used to guide magnetic flux.

It is also desirable for the housing to be relatively small, such as less than about one inch tall and/or less than about two inches in diameter. This permits the inductive energy converter to be installed in small spaces, such as within the heel of a shoe.

Typically, the at least one magnet comprises two magnets. These two magnets may be part of a spring-mass system that includes comprises a flexure spring positioned between the two magnets. Alternatively, the two magnets may be part of a spring-mass system that includes two flexure springs, one of the two flexure springs positioned at a first end of the housing and another of the two flexure springs positioned at a second, opposite end of the housing.

To harvest energy, the at least one induction coil can be coupled to an electrical conductor passing through the housing. The electrical conductor can, in turn, be coupled to a Cockcroft Walton voltage multiplier circuit.

Optionally, the outer shell of the housing is sealed against the atmosphere. Thus, for example, the outer shell of the housing can maintain an environment above atmospheric pressure.

According to another aspect of the disclosure, an inductive energy converter includes: a non-magnetic housing having a longitudinal axis; at least one magnet disposed within the housing; at least one induction coil disposed within the housing; and at least one spring coupled to the at least one magnet or the at least one induction coil, thereby forming a spring-mass system that oscillates along an axis substantially parallel to the longitudinal axis of the housing when the housing is subjected to movement. Preferably, the at least one spring is a flexure spring. The at least one spring is typically coupled to the at least one magnet such that, when the housing is subjected to movement, the at least one magnet oscillates along an axis substantially parallel to the longitudinal axis of the housing.

In another embodiment, an inductive energy converter includes: a housing having an upper surface and a lower surface; a push plate forming a portion of the upper surface; a spring disposed within the housing that biases the push plate into a first, undisplaced position; a latch wheel disposed within the housing; a twisted shaft coupled at a first end to the push plate and at a second end to the latch wheel such that, when the push plate is depressed from the first, undisplaced position in a direction substantially towards the lower surface of the housing, the latch wheel rotates; a magnet wheel; mating latches on the latch wheel and the magnet wheel such that, when the latch wheel rotates, the mating latches engage and rotate the magnet wheel; at least one ring magnet segment oriented circumferentially relative to the magnet wheel; and at least one induction coil positioned interior to a circumference of the ring magnet (e.g., radially relative to the magnet wheel), wherein one of the ring magnet and the at least one induction coil is attached or coupled to the magnet wheel such that it rotates when the magnet wheel rotates. In some aspects, the ring magnet is fixed to the magnet wheel such that the ring magnet rotates as the magnet wheel rotates. In other aspects of the invention, the induction coils are attached to the magnet wheel, such that the ring magnet remains stationary and the induction coils rotate with human movement. In either case, when the magnet wheel rotates, the ring magnet and the induction coils are inductively coupled.

Preferably, the twisted shaft is rigidly coupled to the push plate and movably coupled to the latch wheel. Thus, as the push plate is compressed against the spring, the latch wheel will slide relative to the twisted shaft, causing rotation of the latch wheel. This rotation is, in turn, communicated to the magnet wheel via the mating latches, which can include a plurality of protrusions on the latch wheel and a plurality of corresponding recesses on the magnet wheel.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 depicts an inductive energy converter according to a first embodiment of the invention.

FIG. 2 depicts an energy harvesting circuit.

FIG. 2A is a detail of the Cockcroft Walton Voltage Multiplier Circuit shown in FIG. 2.

FIG. 3 depicts an inductive energy converter according to a second embodiment of the invention.

FIG. 4 is a plot of voltage vs. charging time using an inductive energy converter according to the present invention subjected to the motion of human walking at approximately 1 Hz.

FIG. 5 depicts an inductive energy converter according to a third embodiment of the invention.

FIG. 5A depicts a suitable latching mechanism for the one-way latches illustrated in FIG. 5.

FIG. 6 depicts an energy converter circuit suitable for use with the embodiment of the invention depicted in FIG. 5.

FIG. 7 is a plot of power density delivered to a 1 kΩ load resistor vs. magnet wheel rotation in accordance with the embodiment of the invention depicted in FIG. 5.

### DETAILED DESCRIPTION OF THE INVENTION

Voluntary human motion involves kinetic energy. For example, heel striking during walking exhibits a pattern of repeated motion with an approximate periodicity of 1 Hz (higher in the case of running) that can be related to kinetic energy. The instant invention provides an apparatus to convert this mechanical energy into electrical energy.

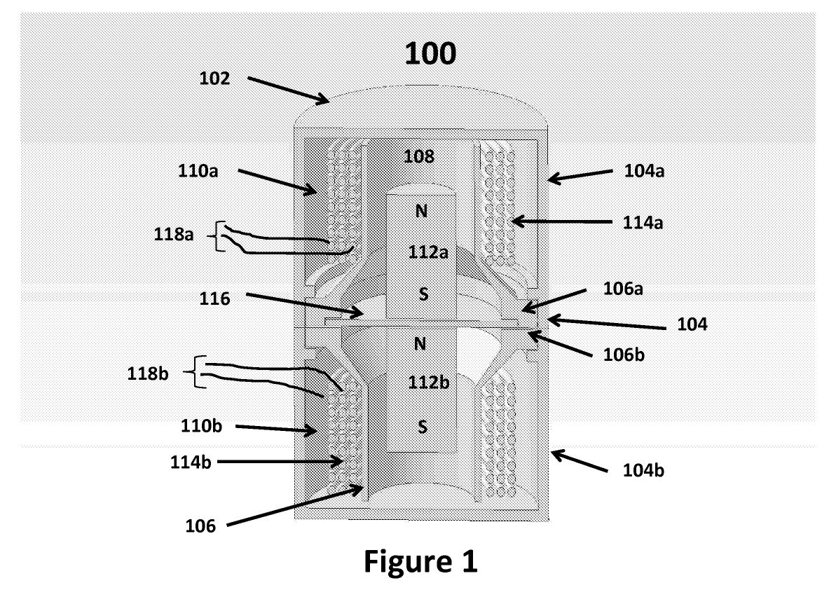

FIG. 1 illustrates an inductive energy converter 100 according to a first embodiment of the invention. Inductive energy converter 100 includes a housing 102, which in turn is made up of an outer shell 104 (e.g., outer shell halves 104a, 104b) and an inner shell 106 (e.g., inner shell halves 106a, 106b).

Housing 102 is preferably made of a non-magnetic material. One suitable material for use in housing 102 is polyvinyl chloride (PVC). Typically, housing 102 is less than about one inch tall and less than about two inches in diameter, making it suitable for installation into small spaces, such as the heel of a shoe.

The various components of housing 102 (e.g., 104a, 104b, 106a, 106b) are joined to each other in any suitable fashion, including the use of adhesives and fasteners. Once joined, inner shell 106 defines a travel channel 108 that is substantially parallel to the longitudinal axis of housing 102. Similarly, outer shell 104 and inner shell 106 together define at least one annular chamber 110 (e.g., annular chambers 110a, 110b).

Outer shell 104 of housing 102 may be sealed against the atmosphere, which isolates the internal components of inductive energy converter 100 from the environment, for example to render inductive energy converter 100 waterproof. It is also contemplated that outer shell 104 of housing 102 may maintain any desirable environment, such as an inert gaseous environment or an environment above atmospheric pressure, which may increase the reliability and/or performance of inductive energy converter 100.

At least one magnet 112 (e.g., magnets 112a, 112b) is disposed within travel channel 108. Magnets 112 are oriented such that their magnetic poles are arranged along an axis that is substantially parallel to the longitudinal axis of housing 102. Suitable materials for magnets 112 include neodymium, iron, and boron.

At least one induction coil 114 (e.g., coils 114a, 114b) is disposed within annular chamber 110 (e.g., within annular chambers 110a, 110b respectively). Induction coils 114 are oriented such that their cross-sections are substantially perpendicular to the longitudinal axis of housing 102. That is, induction coils 114a, 114b are oriented such that (1) they coil around annular chambers 110a, 110b and (2) magnets 112a, 112b pass through the centers of coils 114a, 114b, respectively.

Induction coils 114 may be pre-wound or wound directly on inner shell 106. It is also desirable to bond induction coils 114 to outer shell 104 and/or inner shell 106 to prevent them from moving within annular chambers 110.

Typically, induction coils 114 will include between about 3000 to about 4000 turns of wire. Suitable wire includes, but is not limited to, 36-gauge copper wire. One of ordinary skill in the art will appreciate, however, that the specific number of turns and wire type and size can be adjusted to satisfy specific applications for energy converter 100.

At least one spring 116 is coupled to magnets 112a, 112b, as well as to housing 102, for example where inner shell halves 106a, 106b are joined. Spring 116 is preferably a flexure disk spring. The use of a flexure disk spring reduces the overall size and weight of inductive energy converter 100. Flexure disk springs also exhibit higher resonant frequencies and result in less wobbling in the motion of magnets 112a, 112b, which in turn increases the output of inductive energy converter 100. Of course, other springs, such as coil springs, may be employed, for example where the small size achieved via use of a flexure disk spring is of less necessity. One of ordinary skill in the art will appreciate how to design a suitable spring-mass system (e.g., magnets 112 and springs 116) for a particular application of energy converter 100.

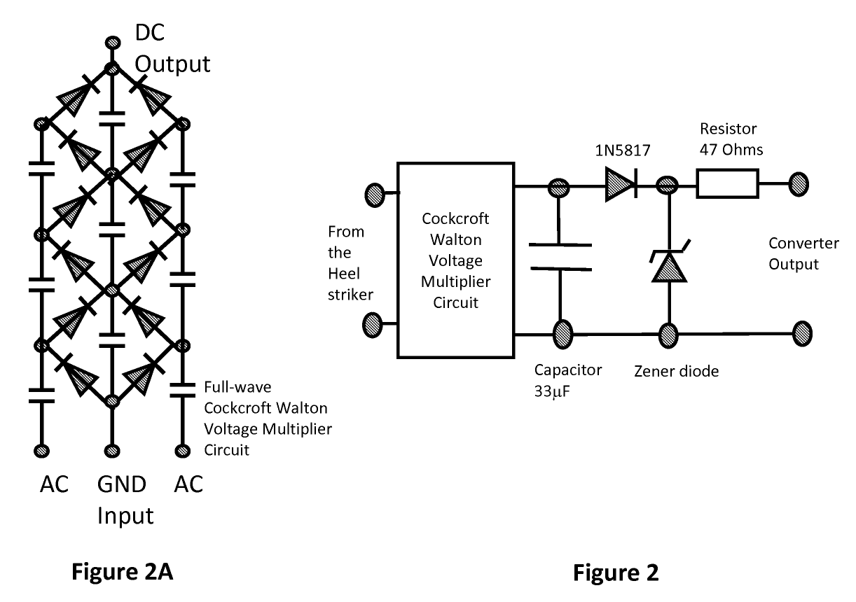

Movement of housing 102 will set the spring-mass system of magnets 112a, 112b and spring 116 in motion. Magnets 112a, 112b will oscillate within travel channel 108 through an interior region of induction coils 114a, 114b and substantially in a direction parallel to the longitudinal axis of housing 102. This, in turn, will induce a current in induction coils 114a, 114b. Electrical energy can thereby be harvested, for example via electrical conductors 118 (e.g., 118a, 118b) passing through housing 102, and either stored or used to power an external device. One suitable circuit for harvesting energy is shown in FIG. 2. FIG. 2A depicts in detail the Cockcroft Walton Voltage Multiplier Circuit shown in block form in FIG. 2.

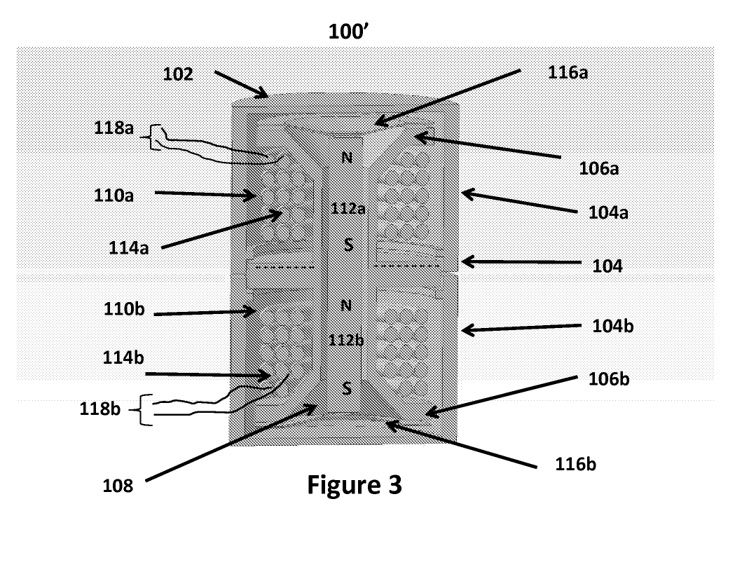

FIG. 3 depicts an inductive energy converter 100′ according to a second embodiment of the present invention. Inductive energy converter 100′ is generally similar to inductive energy converter 100. The principal difference between inductive energy converter 100 and inductive energy converter 100′ is that, whereas inductive energy converter 100 utilizes a spring 116 positioned between magnets 112a and 112b, inductive energy converter 100′ utilizes two springs 116a, 116b positioned at opposite ends of housing 102.

Extant inductive energy converters often increase output by increasing the strength of the magnetic field by using larger magnets and/or by using ferromagnetic materials to channel magnetic flux. Both of these design considerations adversely impact apparatus size and weight. It is therefore desirable to avoid the use of ferromagnetic materials to guide magnetic flux in inductive energy converters according to the present invention. This allows inductive energy converters according to the present invention to be lighter and smaller for a given energy output than extant inductive energy converters.

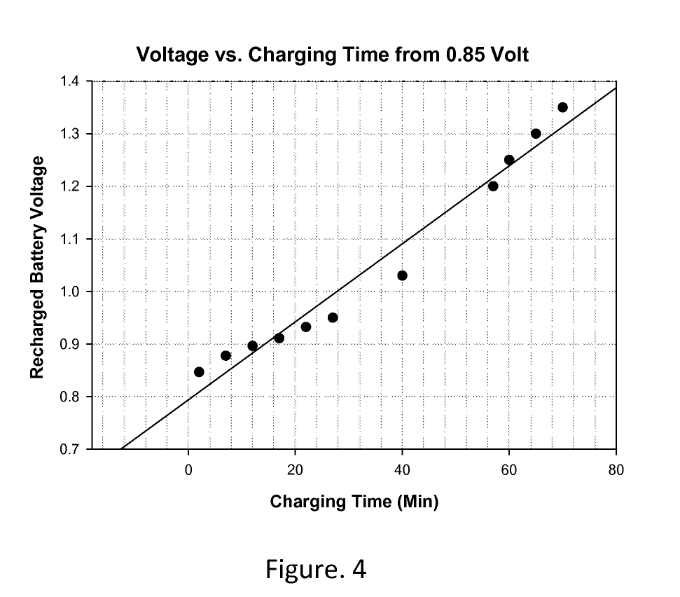

The typical output of an inductive energy converter according to either of the embodiments described above is plotted in FIG. 4. FIG. 4 relates recharged battery voltage to charging time when an inductive energy converter according to the present invention, having dimensions of 0.75 inches tall and 1.75 inches diameter, is subjected to motion at approximately 1 Hz (e.g., human walking) As can be seen in FIG. 4, such an inductive energy converter delivers about 6.9 μW to a 1.5 V rechargeable battery.

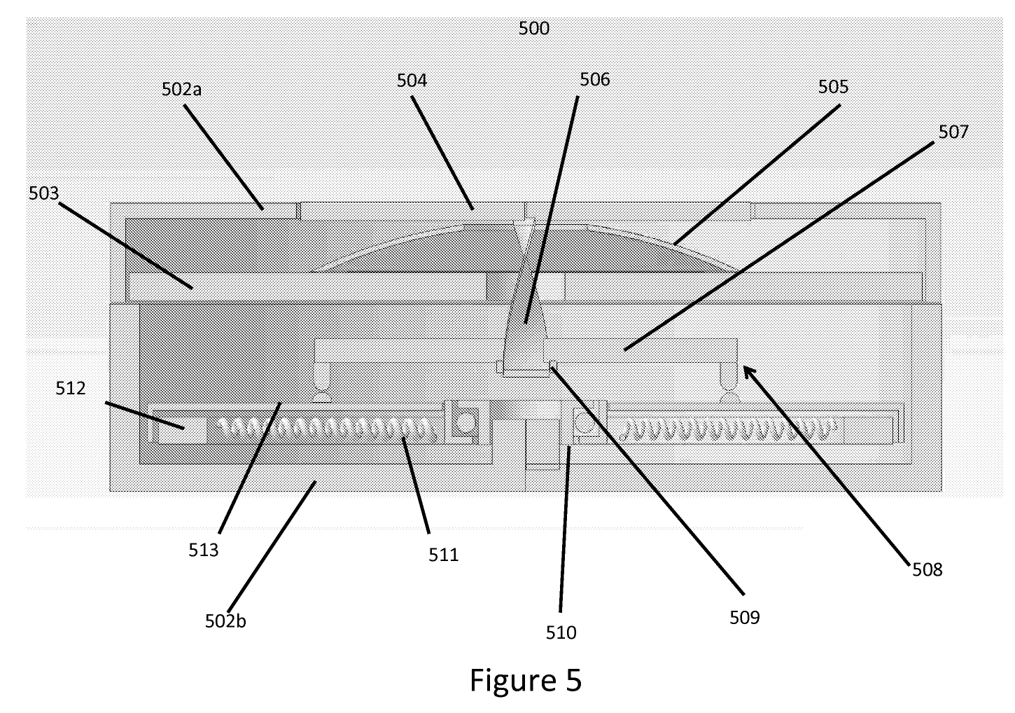

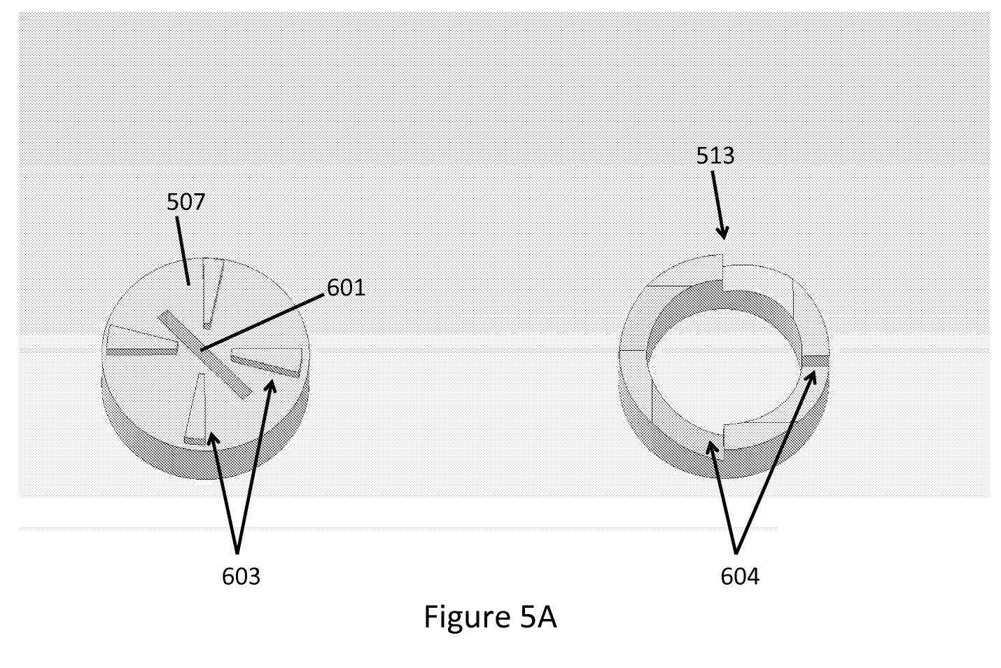

Another embodiment of an inductive energy converter 500 according to the present invention is depicted in FIG. 5. This embodiment of the invention utilizes heel strike displacement of about 0.2 inches and at a frequency of about 1 Hz (when walking) as an initial mechanical input, and does not rely upon vibrational energy.

Energy converter 500 includes a housing having a top surface 502a and a bottom surface 502b. An internal separator element 503 may also separate the interior of the housing into two separate chambers. A portion of top surface 502a is devoted to a push plate 504, which is mounted above a leaf spring 505. Leaf spring 505 biases push plate 504 into a first, undisplaced position. Push plate 504 may be attached to the balance of top surface 502a via an elastic membrane, which further serves to bias push plate 504 into the undisplaced position. Additionally, the membrane may provide hermetic sealing for the interior of energy converter 500.

A twisted shaft 506 is also attached to push plate 504, with the opposite end of twisted shaft 506 connected to a latch wheel 507 via a retainer element 509. The opening of latch wheel 507 within which twisted shaft 506 is received is slightly larger than the cross-sectional area of twisted shaft 506 itself.

Also contained within the housing of energy converter 500 is a magnet wheel 513, which is mounted on a wheel bearing 510. A ring magnet 512, which may be a single, continuous magnet or a series of magnetic segments, is attached to magnet wheel 513 (e.g., to the underside thereof) so as to rotate with magnet wheel 513.

One or more induction coils 511 are located interior to ring magnet 512, typically arranged radially. Induction coils may take any form, but preferably will have about 40 turns and a resistance of about 4.8Ω. Of course, power density can be increased many times over by increasing the number of turns, while still remaining within size constraints (e.g., small enough to fit within a shoe heel) and the wire gauge size.

When in use, a heel strike causes axial displacement of push plate 504 in an axial direction (i.e., towards bottom side 502b of the housing), compressing leaf spring 505. Moreover, as push plate 504 displaces downwards, latch wheel 507 rotates as it slides along the surface of twisted shaft 506.

Latch wheel 507 in turn engages with magnet wheel 513 via a series of mating one-way latches 508 on latch wheel 507 (e.g., on the lower side of latch wheel 507) and magnet wheel 513 (e.g., on the upper side of magnet wheel 513). Thus, as latch wheel 507 turns, so does magnet wheel 513. One-way latches 508 disengage when push plate 504 returns to its original, neutral position (e.g., when leaf spring 505 is released from heel strike compression).

Suitable one-way latches 508 are depicted on latch wheel 507 and magnet wheel 513 in FIG. 5A. The left-hand side of FIG. 5A depicts a series of protrusions 603 on latch wheel 507; also shown is a slot 601 through which twisted shaft 506 passes. On the right-hand side of FIG. 5A, magnet wheel 513 is shown including a series of mating recesses 604. Of course, one of ordinary skill in the art will appreciate that there are numerous ways in which to construct one-way latches 508, all of which are within the spirit and scope of the present invention.

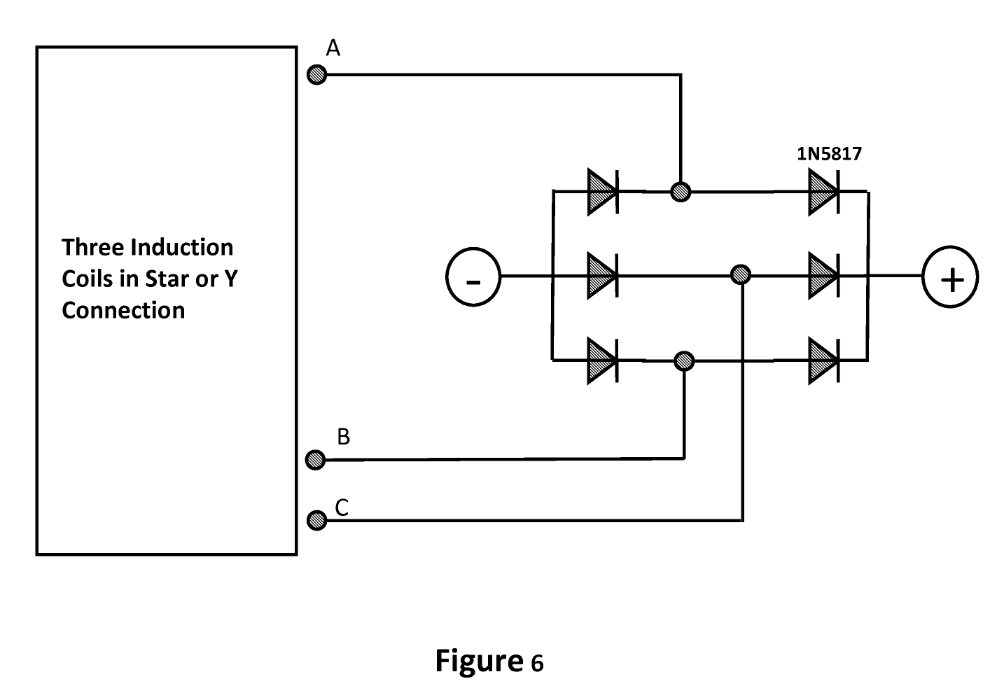

Rotation of magnet wheel 513, and thus ring magnet 512, relative to induction coils 511 yields current and thus electrical energy, which can be harvested using the rectifier circuit depicted in FIG. 6. As shown in FIG. 6, energy converter 500 is arranged so it is connected to a 3-phase generator, with three induction coils connected to terminals A, B, and C of the depicted circuit. Three diodes lead to a positive terminal, while three more diodes lead to a negative terminal. The three DC voltages are added to increase the overall DC output voltage, which does not become zero.

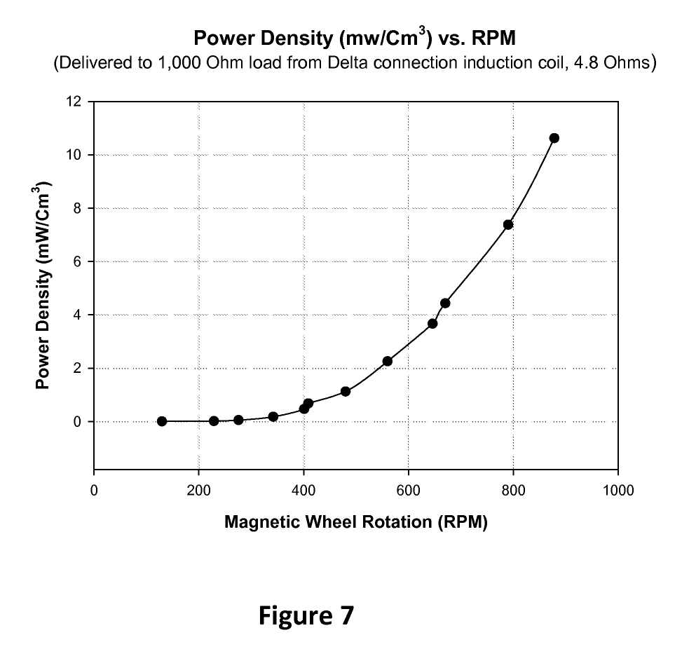

FIG. 7 illustrates power density vs. magnetic wheel rotation for energy converter 500. For three induction coils as described above in a star connection, the resistance is 1 kΩ. The inventors estimate that, at a frequency of about 1 Hz (e.g., walking frequency), magnet wheel 513 will achieve a rotational speed of about 500 RPM, yielding a power density of over 1 mW/cm³. If the volume of the magnetic wheel 513 and induction coils 511 is about 21.7 cm³, the power delivered from energy converter 500 to the 1 kΩ load is over 21 mW.

Although several embodiments of this invention have been described above with a certain degree of particularity, those skilled in the art could make numerous alterations to the disclosed embodiments without departing from the spirit or scope of this invention. For example, although FIGS. 1 and 3 depict axisymmetric devices, human motion will not necessarily impart a perfectly symmetrical motion along the longitudinal axis of the device. Thus, slightly non-symmetrical structures can be used without departing from the spirit and scope of the present invention.

As another example, the device could be modified such that the magnets remain stationary while the induction coils vibrate with human motion. That is, the mass in the spring-mass system set in motion by movement of the housing may be either the magnets or the induction coils. Similarly, energy converter 500 could be constructed such that ring magnet 512 remains stationary while induction coils 511 rotate with human motion.

Still another example is the addition of magnets outside of the induction coils (e.g., mounted on the outer surface of the outer shell) to increase the magnetic flux linkage for an increased induction voltage.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. An inductive energy converter, comprising:
a housing having a longitudinal axis and including an inner shell and an outer shell, wherein
the inner shell defines a travel channel substantially parallel to the longitudinal axis of the housing, and
the inner shell and outer shell define at least one annular chamber therebetween;
at least one magnet disposed within the travel channel, wherein the at least one magnet is oriented such that its magnetic poles lie along an axis substantially parallel to the longitudinal axis of the housing;
at least one induction coil disposed within the at least one annular chamber, wherein the at least one induction coil is oriented with its cross-sectional area substantially perpendicular to the longitudinal axis of the housing; and
at least one spring coupled to the at least one magnet and the housing such that, when the at least one magnet is set in motion via movement of the housing, the at least one magnet oscillates within the travel channel, through an interior region of the at least one induction coil, and substantially in a direction parallel to the longitudinal axis of the housing.

2. The inductive energy converter according to claim 1, wherein the housing comprises a non-magnetic material.

3. The inductive energy converter according to claim 1, wherein:
the at least one magnet comprises two magnets; and
the at least one spring comprises a flexure spring positioned between the two magnets.

4. The inductive energy converter according to claim 1, wherein:
the at least one magnet comprises two magnets; and
the at least one spring comprises two flexure springs, one of the two flexure springs positioned at a first end of the housing and another of the two flexure springs positioned at a second, opposite end of the housing.

5. The inductive energy converter according to claim 1, wherein the inductive energy converter is devoid of ferromagnetic materials used to guide magnetic flux.

6. The inductive energy converter according to claim 1, wherein the housing is less than about one inch tall.

7. The inductive energy converter according to claim 1, wherein the housing is less than about two inches in diameter.

8. The inductive energy converter according to claim 1, wherein the at least one induction coil is coupled to an electrical conductor passing through the housing.

9. The inductive energy converter according to claim 8, wherein the electrical conductor is coupled to a Cockcroft Walton voltage multiplier circuit.

10. The inductive energy converter according to claim 1, wherein the outer shell of the housing is sealed against the atmosphere.

11. The inductive energy converter according to claim 10, wherein the outer shell of the housing maintains an environment above atmospheric pressure.

12. An inductive energy converter, comprising:
a non-magnetic housing having a longitudinal axis;
at least one magnet disposed within the housing;
at least one induction coil disposed within the housing; and
at least one spring coupled to the at least one magnet or the at least one induction coil, thereby forming a spring-mass system that oscillates along an axis substantially parallel to the longitudinal axis of the housing when the housing is subjected to movement.

13. The inductive energy converter according to claim 12, wherein the at least one spring comprises a flexure spring.

14. The inductive energy converter according to claim 12, wherein the at least one spring is coupled to the at least one magnet such that, when the housing is subjected to movement, the at least one magnet oscillates along an axis substantially parallel to the longitudinal axis of the housing.

15. The inductive energy converter according to claim 12, wherein the housing is less than about one inch tall and less than about two inches in diameter.

16. An inductive energy converter, comprising:
a housing having an upper surface and a lower surface;
a push plate forming a portion of the upper surface;
a spring disposed within the housing that biases the push plate into a first, undisplaced position;
a latch wheel disposed within the housing;
a twisted shaft coupled at a first end to the push plate and at a second end to the latch wheel such that, when the push plate is depressed from the first, undisplaced position in a direction substantially towards the lower surface of the housing, the latch wheel rotates;
a magnet wheel;
mating latches on the latch wheel and the magnet wheel such that, when the latch wheel rotates, the mating latches engage and rotate the magnet wheel;
at least one ring magnet segment oriented circumferentially relative to the magnet wheel; and
at least one induction coil positioned interior to a circumference of the ring magnet,
wherein one of the ring magnet and the at least one induction coil is attached or coupled to the magnet wheel such that it rotates when the magnet wheel rotates.

17. The inductive energy converter according to claim 16, wherein the ring magnet is fixed to the magnet wheel.

18. The inductive energy converter according to claim 16, wherein the at least one induction coil is oriented along a radius of the magnet wheel.

19. The inductive energy converter according to claim 16, wherein the twisted shaft is rigidly coupled to the push plate and movably coupled to the latch wheel.

20. The inductive energy converter according to claim 16, wherein the mating latches comprise:
a plurality of protrusions on the latch wheel; and
a plurality of corresponding recesses on the magnet wheel.
